(19) United States
(12) Patent Application Publication
(10) Pub. No.: US 2018/0225981 A1
(43) Pub. Date: Aug. 9, 2018

(54) METHOD AND SYSTEM FOR LEARNING PROGRAMME OUTCOMES MANAGEMENT

(71) Applicant: Lingnan University, Hong Kong (HK)

(72) Inventor: Wai-sing Loo, Hong Kong (HK)

(21) Appl. No.: 15/636,663

(22) Filed: Jun. 29, 2017

Related U.S. Application Data
(60) Provisional application No. 62/454,702, filed on Feb. 3, 2017.

(51) Int. Cl. G09B 5/00; G09B 7/00; G06F 17/30

(52) U.S. Cl. CPC G09B 5/00; G06F 17/30477; G06F 17/30312; G09B 7/00

(57) ABSTRACT

A system for managing learning programme outcomes, comprising: a database configured to maintain in non-transient memory: programme data records, stream data records, course data records, learning goal data records; assessment task data records, rubric data records, and trait data records; wherein the trait data record can be examination type or non-examination type, each examination type trait data record includes grade levels defined by a range of percentage examination mark result, and each non-examination type trait data record includes grade levels defined by a score of a quality level in a trait exhibited by a student; a programme and stream module for managing the programme data records and the stream data records; a course module for managing the course data records; a learning module for managing the learning goal data records; and an assessment module configured for managing the assessment task data records, rubric data records, and trait data records.

### CROSS-REFERENCE TO RELATED APPLICATION

The present Application claims priority to U.S. Provisional Patent Application No. 62/454,702 filed Feb. 3, 2017; the disclosure of which is incorporated herein by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to the management of teaching and learning programmes in academia. Particularly, the present invention relates to tools for assessing students' learning progresses and achievements toward learning goals.

### BACKGROUND OF THE INVENTION

Outcome-based assessment (OBA) is an assessment method for measuring a student's learning progresses and achievements toward learning goals. Its primary function is to improve the success of academic curriculum with special focus on continuously and comprehensively assessing the knowledge and skill components of the student subjected to the academic curriculum. OBA is also designed to evaluate the career readiness of graduates and help assess the effectiveness of the academic curriculum as a whole. The OBA process can be defined as a systematic collection, review, and use of information about educational programmes undertaken for the purpose of improving student learning and development. The process involves the definition of learning goals and objectives, development of measures to evaluate learning, collection and analysis of assessment results for continuous programme improvement.

Particularly, learning goals are generally regarded as broad statements of addressing some or part of the general knowledge and skills. For assessment purposes, a learning goal should be translated into one or more specific learning traits (criteria) which describe measurable attributes. The traits along with a scale of values (levels) on which to rate each trait constitute a scoring rubric to aid assessing student performance. In addition, an assessment process should also be identified to show the specific tasks involved in measuring student performance on the traits corresponding to a learning goal. The assessment results based on the scoring rubric can provide not only a better understanding of how well the subject students achieve the intended learning goals, but also assist in designing improvement strategies and giving feedback to the students.

### SUMMARY OF THE INVENTION

It is an objective of the present invention to provide an OBA system for recording programme intended learning outcomes (PILOs) and their specific objectives and traits; identifying courses and their assessment tasks involved in the assessment of the PILOs; storing and collecting evidence regarding students' attainment of the PILOs; processing rubrics for assessing student achievement in the PILOs and the assessment results of the students; and generating descriptive statistical reports of student performance in achieving the PILOs at different levels. For the rest of this document, the OBA system in accordance to various embodiments of the present invention is referred to as the programme outcomes management system (POMS).

POMS can be implemented by one or more specially configured computer processors running machine instructions to execute the process steps of the OBA method designed in accordance to the various embodiments of the present invention. One or more parts of POMS can be executed in one or more specially configured computer processors in one or more server computers, while other parts of POMS can be executed in one or more specially configured computer processors in one or more computing devices designated for users. These computing devices are in communication with the server computers through data communication networks such as the Internet. These computing devices include, but not limited to, desktop computers, laptop computers, mobile communication devices such as smartphones and tablet computers. POMS is further implemented by one or more specially configured electronic databases, such as relational database management systems (RDBMSs) and/or Lightweight Directory Access Protocol (LDAP) systems, having specially designed data structures and schema.

In one embodiment, POMS can be logically divided into multiple functional modules implemented by sets of machine instructions running in one or more specially configured computer processors. The functional modules are: Programme & Stream module, Course module, Learning module, Assessment module, Report & Data Export module, and User Role module. The Programme & Stream module provides the functionality to add (and define) to POMS, modify, and delete from POMS one or more Programmes and Streams. The Course module provides the functionality to add (and define) to POMS, modify, and delete from POMS one or more Courses and Sessions. The Learning module provides the functionality to add (and define) to POMS, modify, and delete from POMS one or more Learning Goals. The Assessment module provides the functionality to add (and define) to POMS, modify, and delete from POMS one or more Tasks and Rubrics; and facilitates individual student's grading input and recording, and the generation of the students' Overall Performance. The Report & Data Export module provides the functionality to generate one or more Programme report, Stream report, Course report, and commitment table of Learning Goal, Course, Task, Rubric, and/or the students' Overall Performance. The User Role module provides the functionality to add (and define) to POMS, modify, and delete from POMS one or more Users of POMS.

### BRIEF DESCRIPTION OF THE DRAWINGS

Embodiments of the invention are described in more detail hereinafter with reference to the drawings, in which:

FIG. 1 depicts a logical data model of an OBA system in accordance to one embodiment of the present invention;

FIG. 2 further shows the data record structure of the logical data model shown in FIG. 1;

FIG. 3 depicts a logical diagram of the logical functional modules of an OBA system in accordance to one embodiment of the present invention;

FIG. 4 depicts the notations used in the data flow diagrams in FIGS. 5a, 5b, and 6-14;

FIG. 5a depicts a first part of an overall data flow diagram of the OBA system shown in FIG. 3;

FIG. 5b depicts a second part of an overall data flow diagram of the OBA system shown in FIG. 3;

FIG. 6 depicts a more detailed data flow diagram of a Programme and Stream module of the OBA system shown in FIG. 3;

FIG. 7 depicts a more detailed data flow diagram of a Course module of the OBA system shown in FIG. 3;

FIG. 8 depicts a more detailed data flow diagram of a Learning module of the OBA system shown in FIG. 3;

FIG. 9 depicts a more detailed data flow diagram of the management of Assessment Tasks of an Assessment module of the OBA system shown in FIG. 3;

FIG. 10 depicts a more detailed data flow diagram of the management of Rubrics of the Assessment module of the OBA system shown in FIG. 3;

FIG. 11 depicts a more detailed data flow diagram of the management of Assessment Results of the Assessment module of the OBA system shown in FIG. 3;

FIG. 12 depicts a more detailed data flow diagram of a Report & Data Export module of the OBA system shown in FIG. 3; and

FIG. 13 depicts a more detailed data flow diagram of a User Role module of the OBA system shown in FIG. 3.

### DETAILED DESCRIPTION

In the following description, methods and systems for managing teaching and learning programmes, setting and performing assessment on students' learning progresses and achievements toward learning goals are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

The rest of this document adopts the following meanings for the terms listed below:

| Terms | Meanings |
|---|---|
| Programme | A programme is a combination of courses and |
| | requirements which will lead to a degree or diploma |
| | (e.g. Bachelor of Business Administration). |
| Stream | A branch in a field of study. |
| Course | A set of classes on a subject (e.g. Introduction to |
| | Information Technology). |
| Session | Session information includes the academic year and |
| | term, an instructor responsible for the teaching and a |
| | list of enrolled students. |
| Learning Goal | Broad statements of addressing some or part of the |
| | general knowledge and skills (e.g. students having |
| | good chemical analytical skill) |
| Assessment | Assessment Task is the method to assess student's |
| Task | abilities. Examples include tests, essays, examinations, |
| | etc. |
| Assessment | Grading results of the assessment task. |
| Result | |
| Rubric | A statement of the assessment criteria, usually in a |
| | table form. |
| Trait | Description of measurable attributes. Each trait has a |
| | scale of values (levels) on which to rate the trait |
| | qualifiedly or quantifiably. |
| Assurance of | The process which ensures students to achieve the |
| Learning | programme learning goals. |

In accordance to the various embodiments of the present invention, an OBA system, POMS, is implemented by one or more specially configured computer processors running machine instructions to execute the process steps of an OBA method. One or more parts of POMS can be executed in one or more specially configured computer processors in one or more server computers, while other parts of POMS can be executed in one or more specially configured computer processors in one or more user computing devices designated for users. These user computing devices are in communication with the server computers through data communication networks such as the Internet. These computing devices include, but not limited to, desktop computers, laptop computers, mobile communication devices such as smartphones and tablet computers. POMS is further implemented by one or more specially configured electronic databases, such as relational database management systems (RDBMSs) and/or Lightweight Directory Access Protocol (LDAP) systems, having specially designed data structures and schema, and queries. These data structures and schema, and queries impose the data formats and rules of the POMS in its operation of OBA method.

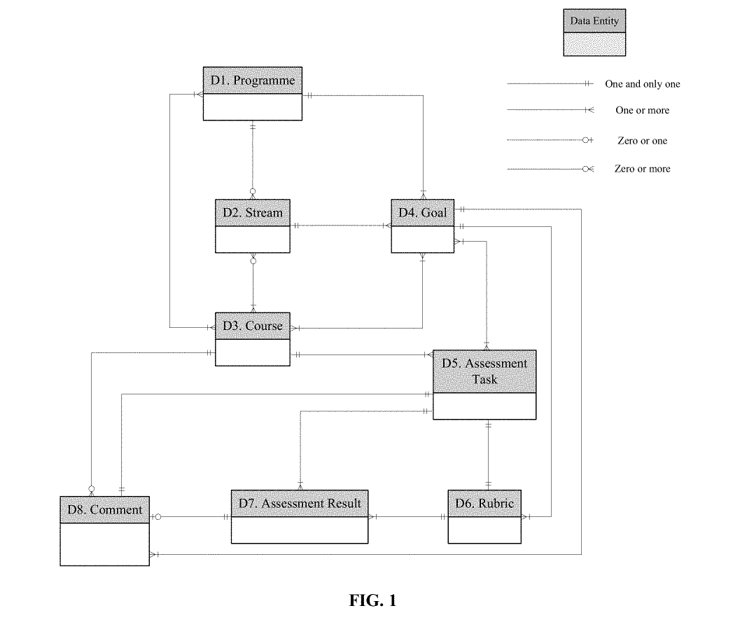

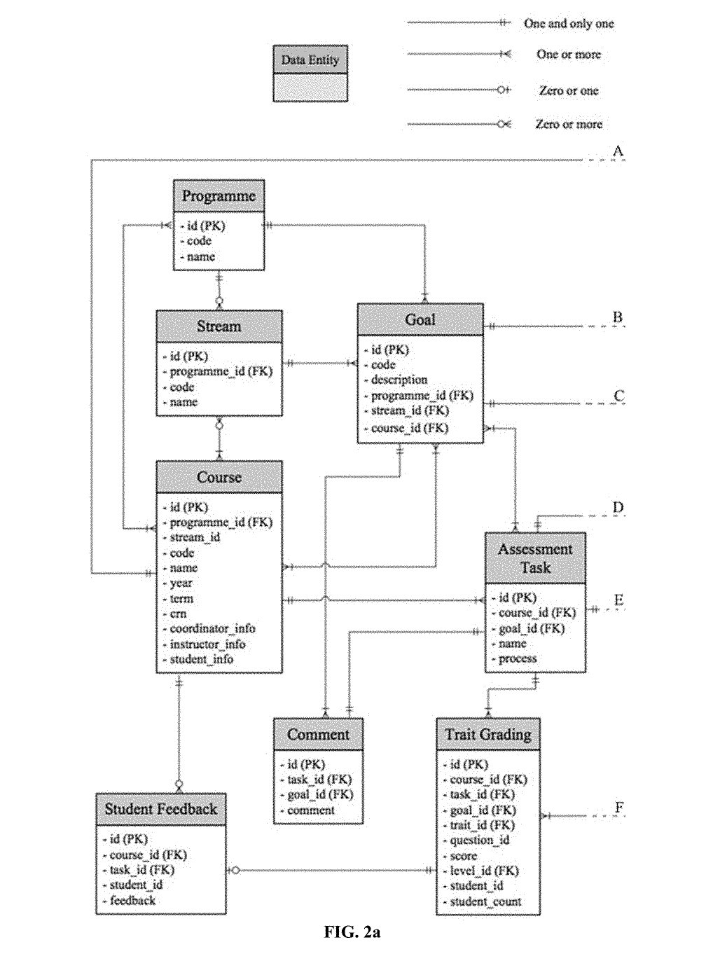

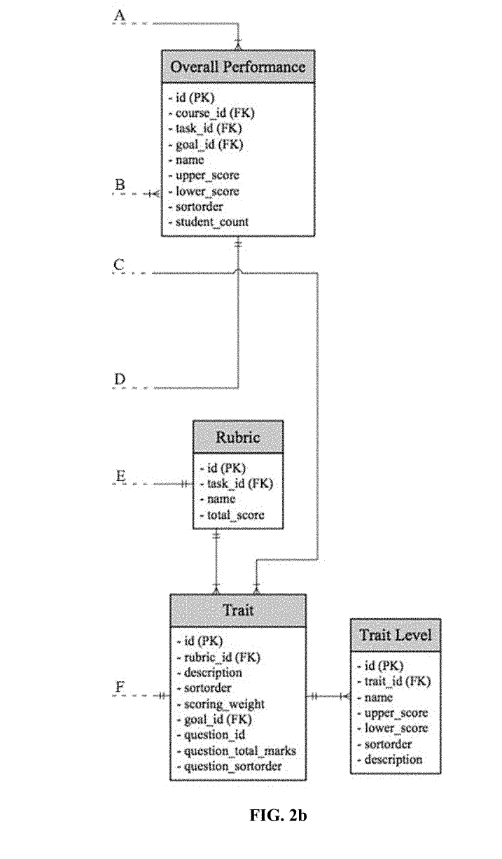

In one embodiment, the OBA method carried out by POMS is defined in part by a logical data model as shown in FIG. 1. In POMS, one or more Programmes D1 are defined. Each Programme D1 contains at least one Learning Goal D4, one Course D3, and zero or more Stream D2. Each Stream D2 must also have at least one Learning Goal D4 defined, and contains at least one Course D3. Each Course D3 belongs at least one, but can be more than one, Programme D1; can belong to more than one, if any, Stream D2; and be associated with at least one, but can be more than one, Learning Goal D4. Each Course D3 must also contain at least one Assessment Task D5. Each Course D3 may also include one or more, if any, Comment D8. Each Learning Goal D4 must define at least one Rubric D6, at least one Assessment Task D5, and at least one Comment D8. Each Assessment Task D5 must have one Rubric D6, one or more Assessment Result D7, and one Comment D8. This logical data model is then implemented by configuring the RDBMS, which includes specifying one or more data record structures in database tables with each data record having at least a reference key to one or more of other data records. FIG. 2 shows an exemplary embodiment of the data record structures implementing the logical data model.

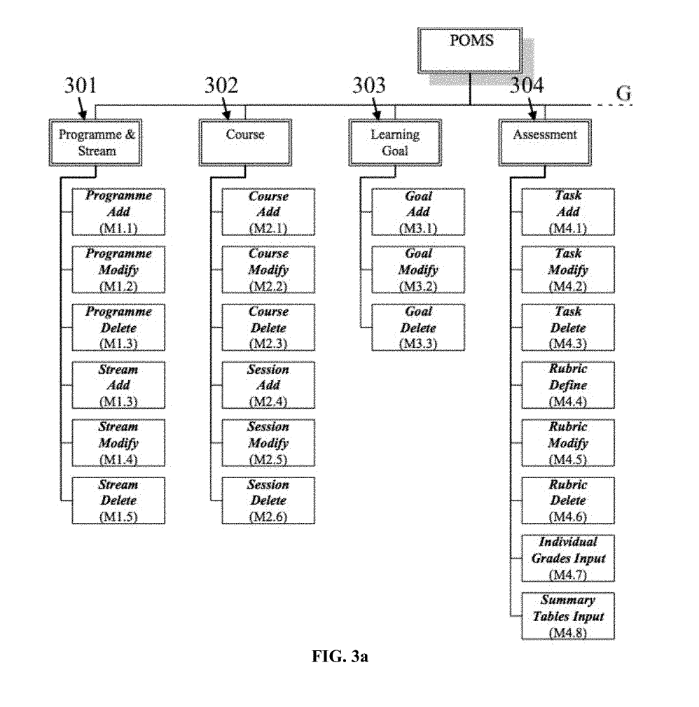

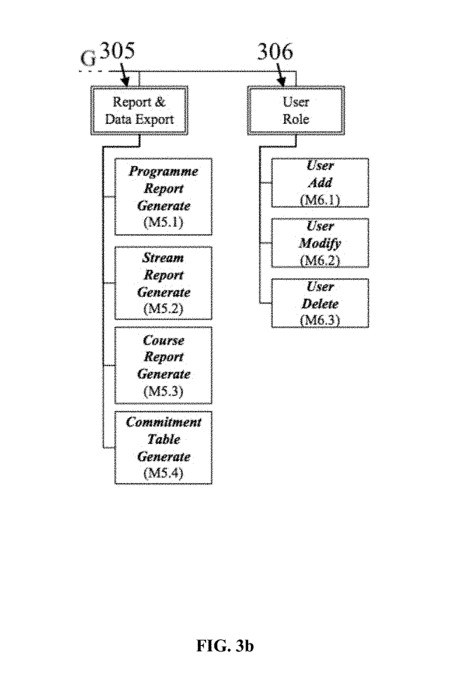

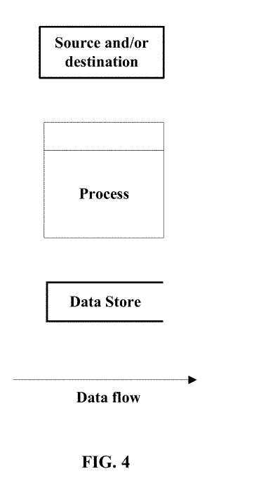

In one embodiment, POMS can be logically divided into multiple functional modules implemented by sets of machine instructions running in one or more specially configured computer processors. Referring to FIG. 3. The functional modules are: Programme & Stream module 301, Course module 302, Learning module 303, Assessment module 304, Report & Data Export module 305, and User Role module 306. The Programme & Stream module 301 provides the functionality to add (and define) to POMS, modify, and delete from POMS one or more Programmes and Streams. The Course module 302 provides the functionality to add (and define) to POMS, modify, and delete from POMS one or more Courses and Sessions. The Learning module 303 provides the functionality to add (and define) to POMS, modify, and delete from POMS one or more Learning Goals. The Assessment module 304 provides the functionality to add (and define) to POMS, modify, and delete from POMS one or more Assessment Tasks and Rubrics; and facilitates individual student grades input and recording, and the generation of the students' Overall Performance. The Report & Data Export module 305 provides the functionality to generate one or more Programme report, Stream report, Course report, and commitment table of Learning Goal, Course, Task, Rubric, and/or the students' Overall Performance. The User Role module 306 provides the functionality to add (and define) to POMS, modify, and delete from POMS one or more users of POMS.

POMS is intended to be used by two classes of users: general users (GUs) and system administrators (SAs). GUs are course coordinators who utilize the OBA system in their own Courses. They can use the features offered by the system, such as specifying which Course Assessment Tasks are involved in the assessment of the PILOs, grading students' achievements in the PILOs based on the pre-defined Rubrics, recording the Assessment Results and generating a report on the students' Overall Performance in achieving the PILOs. SAs are those with expert knowledge of the data and process flow of the system. They are expected to support the GUs in submitting their assessment data to the system. A typical task the SAs perform is to input the PILOs and their specific objectives and Traits in the system. They also need to specify which Courses should be included in the reporting of student achievement in a particular PILO.

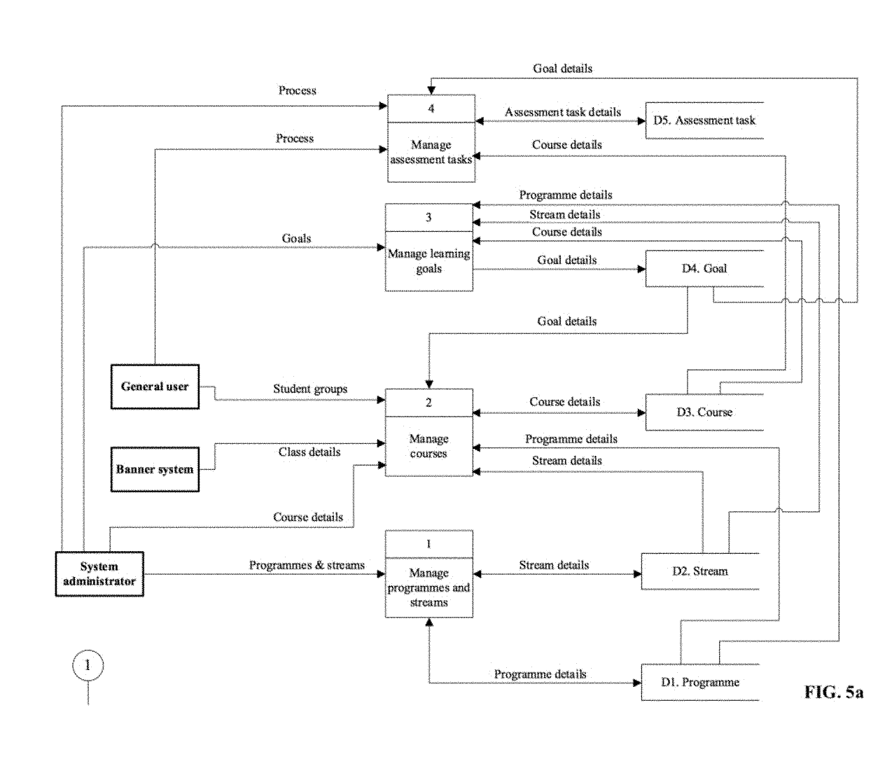

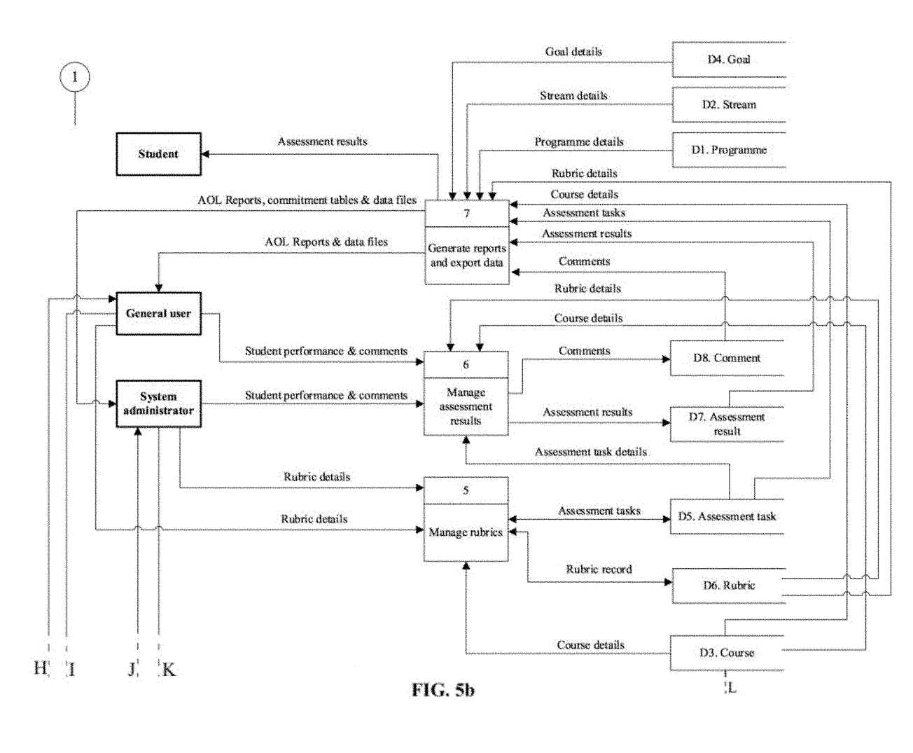

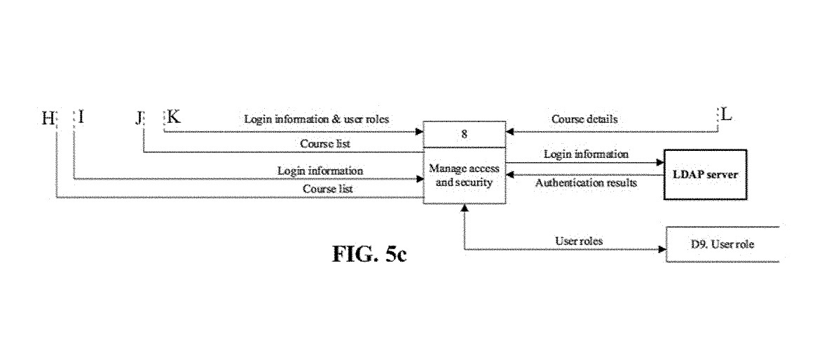

In one embodiment, POMS includes at least a set of machine instructions running in one or more specially configured computer processors in one or more server computers and/or user computing devices that provides a user interface that interacts with a User of POMS, including displaying output to the User and receiving input from the User. The overall dataflow of POMS and its various modules is illustrated in FIGS. 5a and 5b.

Through the use of the POMS user interface, POMS allows a SA to command the Programme and Stream module 301 to create/modify and define a Programme (including a Programme name and a Programme code) and any Stream (including a Stream name and a Stream code) under the Programme, and link any pre-existing Stream to the Programme. The dataflow of the Programme and Stream module 301 is illustrated in FIG. 6.

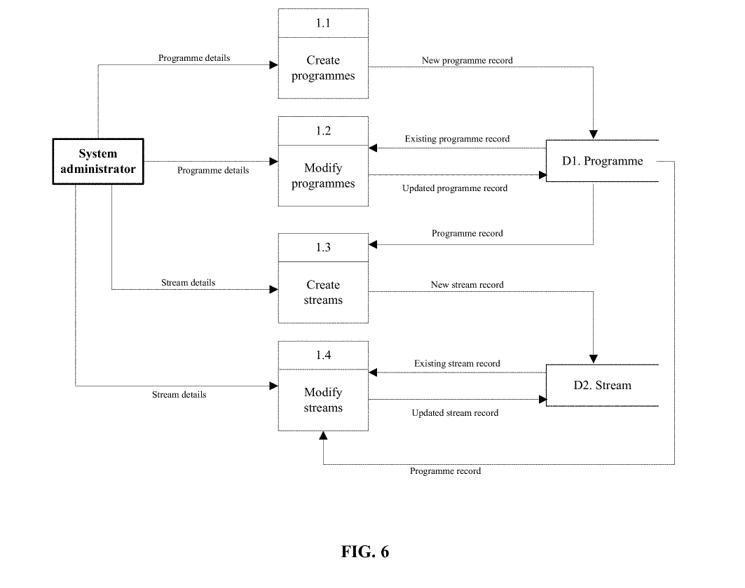

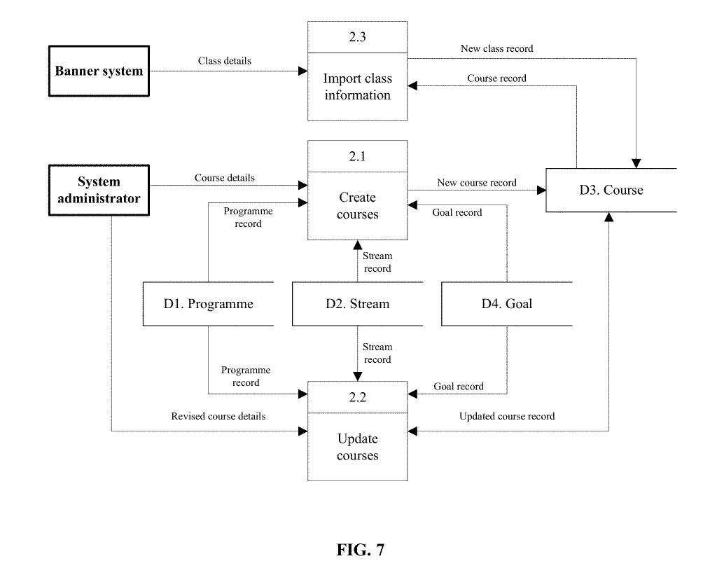

POMS allows the SA to command the Course module 302 to create/modify and define a Course (including a Course name, a Course code, and a coordinator responsible for the Course) and its Session(s) (including the academic year and term of the Session, an instructor responsible for the Session, and a list of enrolled students), and to link the Course to one or more Programmes and Streams. Alternatively, the Course module 302 can import information on one or more Courses from an external system for Course registration (a banner system). The dataflow of the Course module 302 is illustrated in FIG. 7.

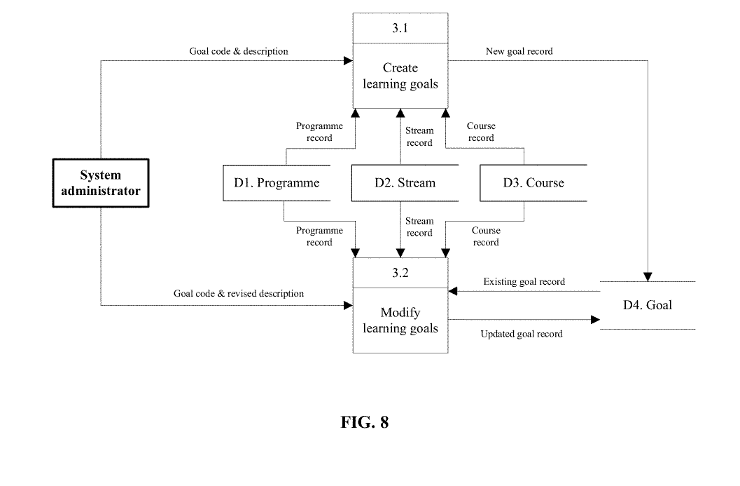

POMS allows the SA to command the Learning module 303 to create/modify and define a Learning Goal (including a Learning Goal code and a Learning Goal description), and to link the Learning Goal to one or more Programmes, Streams, and/or Courses. The dataflow of the Learning module 303 is illustrated in FIG. 8.

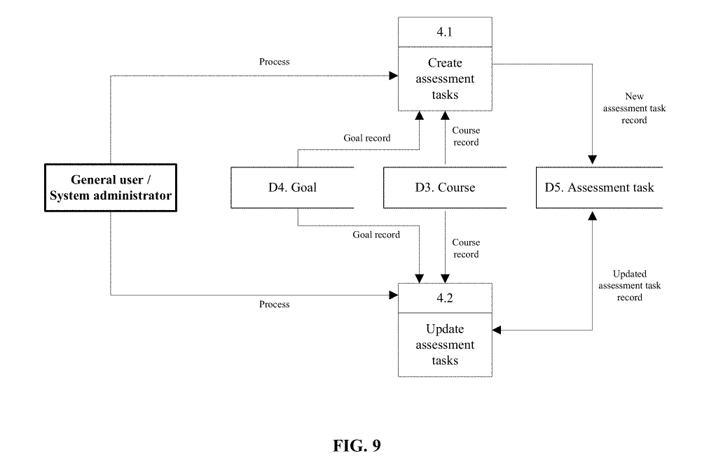

POMS allows the SA or a GU to command the Assessment module 304 to create/modify and define one or more Assessment Tasks (including the process step(s) of the Assessment Tasks) for a Course, and to link the Assessment Tasks to one or more Learning Goals at different levels (Programme, Stream, and Course levels). The dataflow of the aforesaid management of Assessment Tasks is illustrated in FIG. 9.

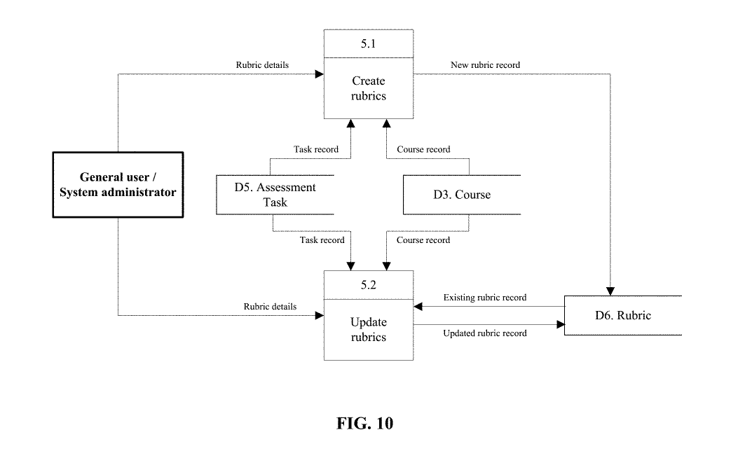

Further, POMS allows the SA or a GU to command the Assessment module 304 to create/modify and define a Rubric (including a description and one or more Traits) for each Assessment Task in each Course. The dataflow of the aforesaid management of Rubrics is illustrated in FIG. 10.

In one embodiment, each Trait is further defined a description (e.g. “able to identify the molecular structures of the organic compounds”) and available grade levels, which can be named e.g. excellent, very good, good, satisfactory, and unsatisfactory. A Trait can be classified as examination type Trait or non-examination type Trait. For examination type Trait, each of its Trait grade levels is further defined a range of percentage corresponding to a range of examination mark result (e.g. 90-100% for excellent, 80-89% for very good, 70-79% for good, 50-69% for satisfactory, and 0-49% for unsatisfactory). For non-examination type Trait, each of its Trait grade levels is further defined a score (e.g. 4 for excellent, 3 for very good, 2 for good, 1 for satisfactory, and 0 for unsatisfactory) corresponding to the quality level in the particular Trait exhibited by a student. The ordering and the score weighting (used in computing the total score for the Rubric) of the Traits, and the ordering of the Trait levels of each Trait can be configured. Each Trait is configured to link to one or more Learning Goals at different levels (Programme, Stream, and Course levels), and to link each Trait to one or more Questions defined. Table 1 below illustrates the grading of students on a particular Rubric.

TABLE 1
Exemplary Students' Grading on a Rubric

| Student | Trait₁ | Trait₂ | Trait₃ | | Traitₘ |
|---|---|---|---|---|---|
| ID | score | score | score | . . . | score |
| S₁ | 3 | 1 | 2 | | 0 |
| S₂ | 0 | 2 | 2 | | 1 |
| S₃ | 0 | 3 | 2 | | 3 |
| . . . | | | | | |
| Sₙ | 3 | 3 | 2 | | 3 |

POMS allows the SA or GU to command the Assessment module 304 to compute the students' Overall Performance on the students' grade level scoring or grade percentage on the Traits in a Rubric. POMS also allows the SA or GU to command the Assessment module 304 to define performance levels to be assigned different ranges of grade level scoring or grade percentage on the Traits in a Rubric achieved by the students. The name and the corresponding ranges of grade level scoring or grade percentage for each performance level can be configured. The Assessment module 304 then retrieves and determines the student count and percentage of the student body in each of the performance levels according to the grade level scoring or grade percentage achieved by the students. The ordering of the performance levels can be configured. Each Overall Performance in a Rubric can be configured to link to one or more quality assurance (QA) criteria. Ultimately, the Assessment module 304 computes the Overall Performance of each Programme in POMS and the Overall Performances of each Stream, Course, and Assessment Task. Table 2 below illustrates the computation of the students' Overall Performance on a particular Rubric of an Assessment Task.

TABLE 2
Exemplary Students' Overall Performance on a Rubric

| | Level[0] | Level[1] | | Level[x] |
|---|---|---|---|---|
| | Student | Student | | Student |
| | count | count | | count |
| | Score | Score | . . . | Score |
| Trait | Range[0] | Range[1] | . . . | Range[x] |
| Trait₁ | 5 | 4 | | 1 |
| Trait₂ | 2 | 3 | | 5 |
| Trait₃ | 3 | 3 | | 4 |
| . . . | | | | |
| Traitₘ | 6 | 2 | | 2 |

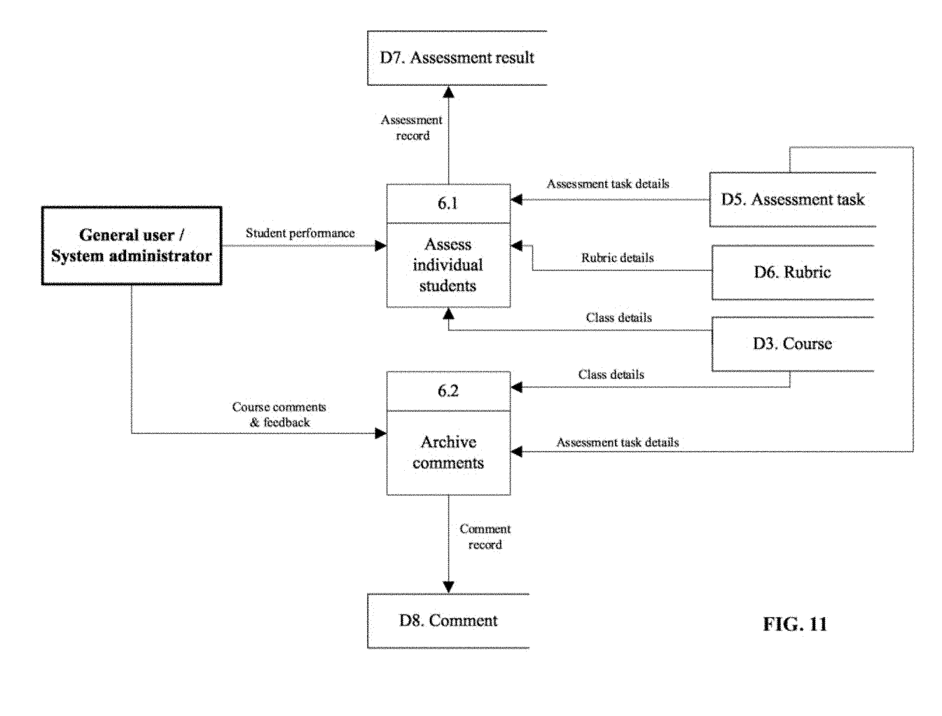

The Assessment module 304 facilitates the input of marks (grade level scoring or grade percentage) of individual student in an Assessment Task by a SA or GU on an assessment e-form of a user interface. The individual students' grade level scoring or grade percentage are then recorded as Trait Grading data records of a Trait in a Rubric under an Assessment Task. Alternatively, the individual students' grade level scoring or grade percentage can be imported (e.g. with certain data file format such as CSV) to POMS from an external system that is used in student grading. Subsequently, POMS allows a SA or GU to command the Assessment module 304 to facilitates the input of feedback comments on an Assessment Task by the students. POMS allows a SA or GU to command the Assessment module 304 to facilitates any adjustment of grade level scoring or grade percentage recorded in any Trait Grading data record of a Trait in a Rubric under an Assessment Task. The dataflow of the aforesaid management of Assessment Results is illustrated in FIG. 11.

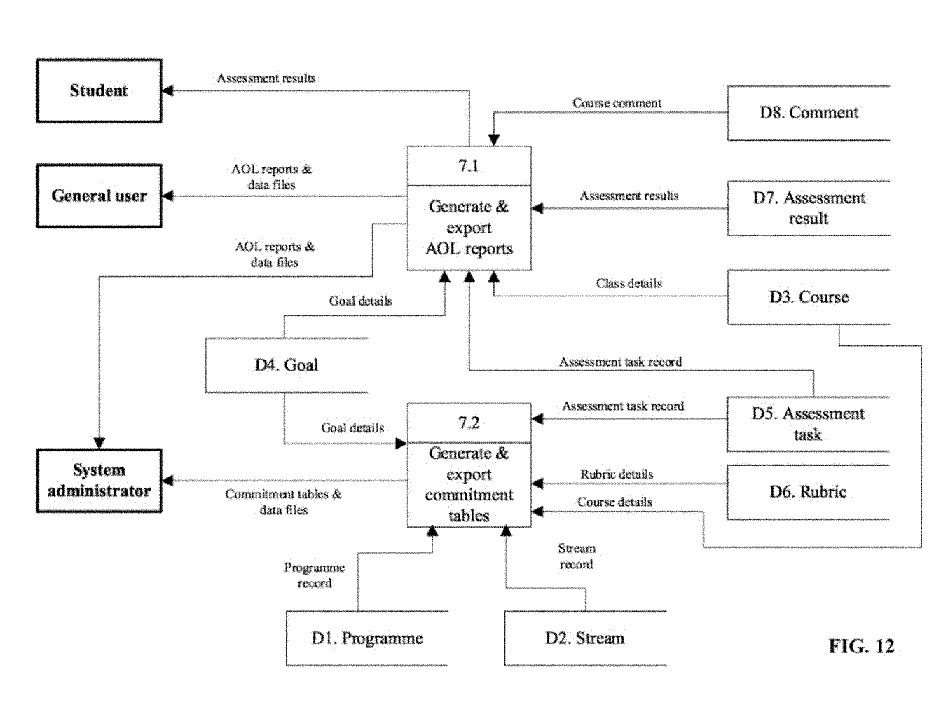

POMS allows a SA or GU to command the Report & Data Export module 305 to generate one or more reports for each Learning Goal at different levels (Programme, Stream, and Course levels). Each report comprises the name and description of the Learning Goal, Course name, the academic year and term of the Sessions of the Course, total number of students enrolled in the Course, the process step(s) of the Assessment Tasks associated with the Course, the QA criteria associated with the Rubric of each of the Assessment Tasks, individual student's grading in the Traits of each of the Rubric, and the students' Overall Performance in the Course and each of the Rubric of the Assessment Tasks. A SA can also command the Report & Data Export module 305 to generate one or more reports of Assurance of Learning (AOL) commitment table at different levels (Programme, Stream, and Course levels). The AOL commitment table comprises the names and descriptions of the Learning Goals, specific objectives and Traits, the process step(s) of the Assessment Tasks, method of collecting evidence, storage of data, data collection period, primary stakeholders, the Courses involved, the Traits, their levels, and their targets (QA criteria). The Report & Data Export module 305 can generate the aforementioned reports by the academic year so to allow historical comparison of data. The Report & Data Export module 305 can also export the reports generated to external system in specific data file formats (e.g. CSV). The dataflow of the Report & Data Export module 305 is illustrated in FIG. 12.

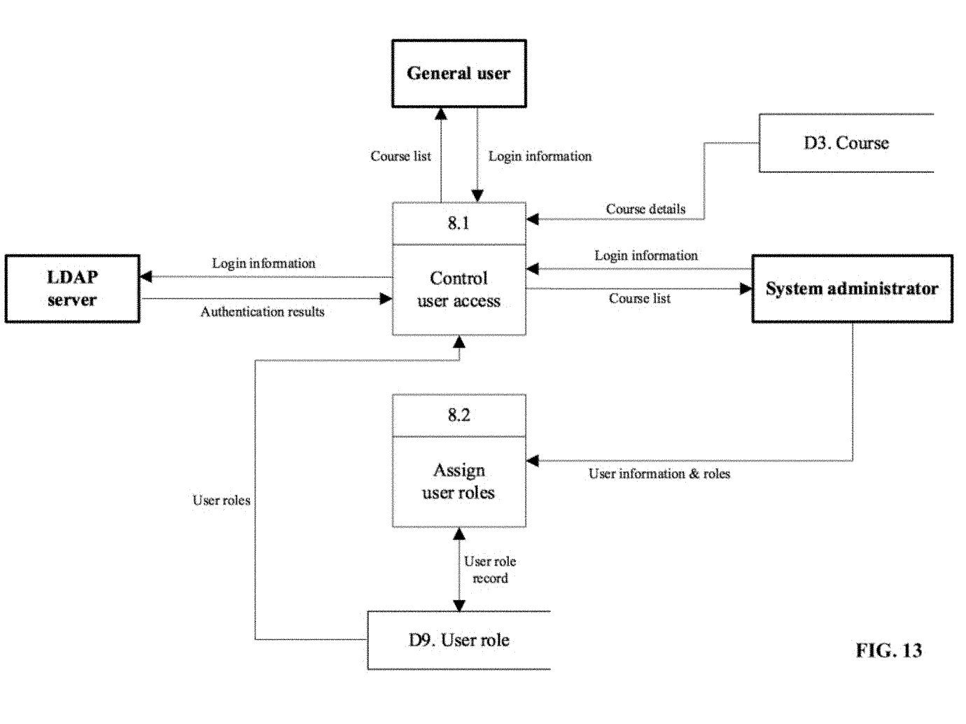

POMS allows a SA to command the User Role module 306 to assign Roles (e.g. System Administrator Role and General User Role) to users registered in POMS. The User Role module 306 also performs user authentication and access control to the modules and functionalities of POMS. Further, the User Role module 306 can be configured to access an external user directory of user identity, credential, and Roles data records in the performance of user identity management, user authentication, and access control. The dataflow of the User Role module 306 is illustrated in FIG. 13.

The system embodiments disclosed herein may be implemented using general purpose or specialized computing devices, computer processors, or electronic circuitries including but not limited to application specific integrated circuits (ASIC), field programmable gate arrays (FPGA), and other programmable logic devices configured or programmed according to the teachings of the present disclosure. Computer instructions or software codes running in the general purpose or specialized computing devices, computer processors, or programmable logic devices can readily be prepared by practitioners skilled in the software or electronic art based on the teachings of the present disclosure.

All or portions of the system embodiments may be executed in one or more general purpose or computing devices including server computers, personal computers, laptop computers, kiosks, mobile computing devices such as smartphones and tablet computers.

The system embodiments include computer storage media having computer instructions or software codes stored therein which can be used to program computers or microprocessors to perform any of the processes of the present invention. The storage media can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. A system for managing learning programme outcomes, comprising:
an electronic database configured to maintain in non-transient memory:
one or more programme data records;
one or more stream data records;
one or more course data records;
one or more learning goal data records;
one or more assessment task data records;
one or more rubric data records; and
one or more trait data records;
wherein each of the programme data records is linked to at least one learning goal data record and at least one course data record;
wherein each of the stream data records is linked to at least one learning goal data record, at least one course data record, and at last one programme data record;
wherein each of the course data records is linked to at least one learning goal data record and at least one assessment task data record, and each of the course data record includes session data;
wherein each of the assessment task data records is linked to one rubric data record and at least one assessment result data record;
wherein each of the rubric data records is linked to one or more trait data records;
wherein each of the trait data records is an examination type trait data record or a non-examination type trait data record;
wherein each examination type trait data record includes one or more grade levels, each defined by a range of percentage corresponding to a range of examination mark result;
wherein each non-examination type trait data record includes one or more grade levels, each defined by a score corresponding to a quality level in a trait exhibited by a student;
a programme and stream module executed by one or more computer processors configured to add, modify, or delete one or more of the programme data records and the stream data records upon receiving a user input;
a course module executed by one or more computer processors configured to add, modify, or delete one or more of the course data records upon receiving a user input;
a learning module executed by one or more computer processors configured to add, modify, or delete one or more of the learning goal data records upon receiving a user input; and
an assessment module executed by one or more computer processors configured to add, modify, or delete one or more of the assessment task data records, rubric data records, and trait data records upon receiving a user input.

2. The system of claim 1, wherein the one or more computer processors executing the assessment module is further configured to compute a students' overall performance for a learning goal at a level selected from programme, stream, and course by:
retrieving from the electronic database the one or more rubric data records that are linked to the one or more assessment task data records that are linked to the learning goal data record corresponding to the learning goal that is linked to a programme data record corresponding to the programme, a stream data record corresponding to the stream, or a course data record corresponding to the course;
retrieving from the electronic database the one or more trait data records linked to the retrieved one or more rubric data records;
retrieving from the electronic database a number of student who reported a trait quality level that is at each of the trait grade levels or an examination mark result that is within in each of the trait grade percentage ranges of the retrieved trait data records;
receiving a configuration input for one or more performance levels, each performance level corresponding to a range of trait grade levels or a range of trait grade percentage ranges;
determining a number of student corresponding to the range of trait grade levels or the range of trait grade percentage ranges of each performance level; and
compiling the students' overall performance based on an aggregation of the determined numbers of student corresponding to the performance levels.

3. The system of claim 1, further comprising:
a report and data export module executed by one or more computer processors configured to generate:
one or more reports of students' overall performance for each learning goal at a level selected from programme, stream, and course; and
one or more reports of assurance of learning commitment table at a level selected from programme, stream, and course.

4. A method for managing learning programme outcomes, comprising:
providing an electronic database configured to maintain in non-transient memory:
one or more programme data records;
one or more stream data records;
one or more course data records;
one or more learning goal data records;
one or more assessment task data records;
one or more rubric data records; and
one or more trait data records;
wherein each of the programme data records is linked to at least one learning goal data record and at least one course data record;
wherein each of the stream data records is linked to at least one learning goal data record, at least one course data record, and at last one programme data record;
wherein each of the course data records is linked to at least one learning goal data record and at least one assessment task data record, and each of the course data record includes session data;
wherein each of the assessment task data records is linked to one rubric data record and at least one assessment result data record;
wherein each of the rubric data records is linked to one or more trait data records;
wherein each of the trait data records is an examination type trait data record or a non-examination type trait data record;
wherein each examination type trait data record includes one or more grade levels, each defined by a range of percentage corresponding to a range of examination mark result;
wherein each non-examination type trait data record includes one or more grade levels, each defined by a score corresponding to a quality level in a trait exhibited by a student;
adding, modifying, or deleting one or more of the programme data records and the stream data records upon receiving a user input;
adding, modifying, or deleting one or more of the course data records upon receiving a user input;
adding, modifying, or deleting one or more of the learning goal data records upon receiving a user input; and
adding, modifying, or deleting one or more of the assessment task data records, rubric data records, and trait data records upon receiving a user input.

5. The method of claim 4, further comprising computing a students' overall performance for a learning goal at a level selected from programme, stream, and course, the computation of the students' overall performance comprises:
retrieving from the electronic database the one or more rubric data records that are linked to the one or more assessment task data records that are linked to the learning goal data record corresponding to the learning goal that is linked to a programme data record corresponding to the programme, a stream data record corresponding to the stream, or a course data record corresponding to the course;
retrieving from the electronic database the one or more trait data records linked to the retrieved one or more rubric data records;
retrieving from the electronic database a number of student who reported a trait quality level that is at each of the trait grade levels or an examination mark result that is within in each of the trait grade percentage ranges of the retrieved trait data records;
receiving a configuration input for one or more performance levels, each performance level corresponding to a range of trait grade levels or a range of trait grade percentage ranges;
determining a number of student corresponding to the range of trait grade levels or the range of trait grade percentage ranges of each performance level; and
compiling the students' overall performance based on an aggregation of the determined numbers of student corresponding to the performance levels.

6. The method of claim 4, further comprising:
generating one or more reports of students' overall performance for each learning goal at a level selected from programme, stream, and course; and
generating one or more reports of assurance of learning commitment table at a level selected from programme, stream, and course.
